(19) United States
(12) Patent Application Publication
(10) Pub. No.: US 2025/0157443 A1
(43) Pub. Date: May 15, 2025

(54) VOICE OVER MUSIC RECORDING FOR ELECTRONIC DEVICES

(71) Applicant: Apple Inc., Cupertino, CA (US)

(72) Inventors: Mehrez SOUDEN, Los Angeles, CA (US); Aaftab A. MUNSHI, Los Gatos, CA (US); Dogac BASARAN, London (GB); Jonathan D. HOGG, Los Gatos, CA (US); Jonathan D. SHEAFFER, San Jose, CA (US); Joshua D. ATKINS, Lexington, MA (US); Matthias MAUCH, London (GB); Tony S. VERMA, San Francisco, CA (US); Troy D. SCHULTZ, Los Gatos, CA (US); Vijay SUNDARAM, San Ramon, CA (US)

(21) Appl. No.: 18/821,846

(22) Filed: Aug. 30, 2024

Related U.S. Application Data
(60) Provisional application No. 63/599,548, filed on Nov. 15, 2023.

(51) Int. Cl. G10H 1/36; G10L 21/0208; G10L 21/028; H04S 7/00

(52) U.S. Cl. CPC G10H 1/366; G10L 21/0208; G10L 21/028; H04S 7/302; G10H 2210/005; G10H 2210/281; G10L 2021/02082; H04S 2400/11; H04S 2400/15

(57) ABSTRACT

Systems, devices, and methods for voice over music recording are provided. A person may sing along with music being output into the physical environment of the person by a loudspeaker. One or more microphones may be used to record both the voice of the person singing, and the music output by the speaker. An electronic device may cancel the portion of the microphone signals containing the music output by the speaker, and remix the voice of the person with digital audio content corresponding to the music.

### CROSS REFERENCE TO RELATED APPLICATIONS

This application claims the benefit of priority to U.S. Provisional Patent Application No. 63/599,548, entitled, “Voice Over Music Recording For Electronic Devices”, filed on Nov. 15, 2023, the disclosure of which is hereby incorporated herein in its entirety.

### TECHNICAL FIELD

The present description relates generally to electronic devices including, for example, to voice over music recording for electronic devices.

### BACKGROUND

Electronic devices are often used to output music from a speaker of the electronic device. The music can be stored at an electronic device for output, or can be streamed from a streaming service at the time of output. Some electronic devices provide the ability to control the amount of an original signer that is included in the music output from the speaker, so that a user of the electronic device can sing along with the music, and potentially without the original singer.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates an example system architecture including various electronic devices that may implement the subject system in accordance with one or more implementations.

FIG. 2 illustrates a system performing voice over music recording in accordance with implementations of the subject technology.

FIG. 3 illustrates an example of an electronic device performing voice over music recording in accordance with implementations of the subject technology.

FIG. 4 illustrates an example of an electronic device performing voice over music recording using an audio input received from another electronic device in accordance with implementations of the subject technology.

FIG. 5 illustrates a system performing voice over music recording with real-time playback in accordance with implementations of the subject technology.

FIG. 6 illustrates a flow diagram for an example process for voice over music recording in accordance with implementations of the subject technology.

FIG. 7 illustrates a flow diagram for another example process for voice over music recording in accordance with implementations of the subject technology.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject disclosure can provide a user of an electronic device with the ability to generate a recording of their voice, such as over music being played by a loudspeaker. For example, music may be output by a speaker of an electronic device (e.g., a portable electronic device such as a smartphone, a tablet, or a laptop; a wireless speaker such as a Bluetooth speaker; or a television coupled to a set top box). One or more microphones of the electronic device or another electronic device may be used to record a combination of (i) the music that is output by the speaker, and (ii) a person singing along to the music. The electronic device or the other electronic device may then separate out the user's voice from the music in the recording, and re-combine the separated user's voice with digital audio content corresponding to the music. This re-combination facilitates other processing, such as noise suppression, dereverberation, style matching to the original music, spatialization of the user's own voice, and/or remixing of the original audio content, as described in further detail hereinafter.

In this way, a user may be provided with the ability to make a high quality recording of their own singing voice together with prerecorded music, without, for example, requiring specialized recording equipment such as a sound-isolated recording studio and/or wired microphones.

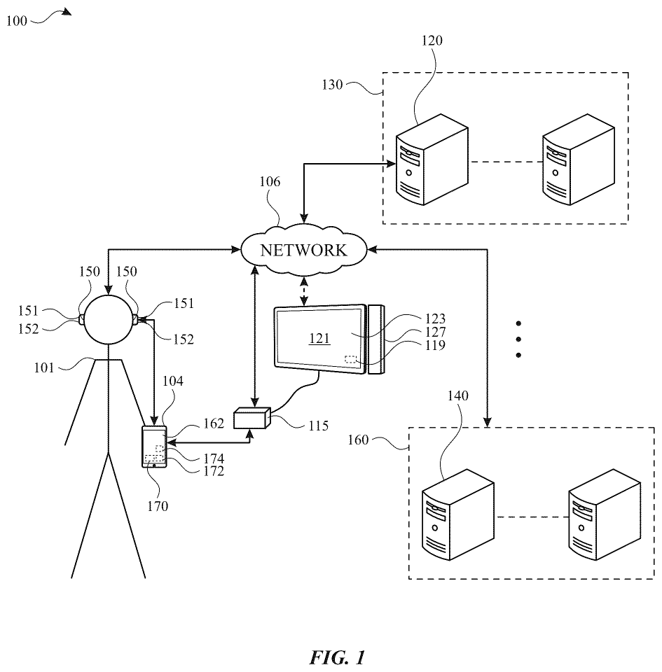

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio output device 150, an electronic device 104 (e.g., a handheld electronic device such as a smartphone or a tablet, or a wearable electronic device such as a smart watch or a head worn device), a media output device 115 (e.g., a set top box or the like), a display device 123 (e.g., a television, monitor, or other device with a display and/or one or more speakers), a speaker device 127 (e.g., a wired or wireless speaker, such as a Bluetooth speaker or a smart speaker), one or more servers 120, and/or one or more servers 140 communicatively coupled by a network 106 (e.g., a local or wide area network). For explanatory purposes, the system architecture 100 is illustrated in FIG. 1 as including the audio output device 150, the electronic device 104, the media output device 115, the display device 123, the speaker device 127, the server(s) 120, and the server(s) 140; however, the system architecture 100 may include any number of electronic, media output, speaker, display, and/or audio output devices and any number of servers and/or a data centers including multiple servers.

The audio output device 150 may be implemented as a wireless audio output device such as a smart speaker, a wearable audio output device such as headphones (e.g., a pair of speakers mounted in speaker housings that are coupled together by a headband) or an earbud (e.g., an earbud of a pair of earbuds each having a speaker disposed in a housing that conforms to a portion of the user's ear) configured to be worn by a user 101 (also referred to as a wearer when the wireless audio output device is worn by the user), or may be implemented as any other device capable of outputting audio and/or video and/or other types of media (e.g., and configured to be worn by a user). Each audio output device 150 may include one or more audio output components such as one or more speakers 151 configured to project sound into (e.g., directly into) an ear of the user 101, and one or more microphones, such as microphones 152. The audio output device 150 may be communicatively coupled to the electronic device 104 and/or the media output device 115, such as via the network 106 or via a direct wireless connection, such as a Bluetooth connection or a direct WiFi connection. In one or more implementations, the audio output device 150 may be communicatively coupled to the network 106 via the connection with the electronic device 104. In one or more other implementations, the audio output device 150 may optionally be capable of connecting directly to the network 106 (e.g., without a connection to the electronic device 104).

In one or more implementations, the audio output device 150 may also include other components, such as one or more inertial sensors and/or one or more display components (not shown) for displaying video or other media to a user. Although not visible in FIG. 1, each audio output device 150 may include processing circuitry (e.g., including memory and/or one or more processors) and communications circuitry (e.g., one or more antennas, etc.) for receiving and/or processing audio content from the electronic device 104 or another electronic device. The processing circuitry of the audio output device 150 may operate the speaker 151 to generate sound (also referred to herein as audio output) corresponding to audio content received from the electronic device 104. The processing circuitry of the audio output device 150 may operate the microphone(s) 152 to receive audio inputs including voices and/or music, and may processes the audio inputs as described herein. The audio output device may include a power source such as a battery and/or a wired or wireless power source.

The audio output device 150 may include communications circuitry for communications (e.g., directly or via network 106) with the electronic device 104, the media output device 115, the server 120, and/or the server 140, the communications circuitry including, for example, one or more wireless interfaces, such as WLAN radios, cellular radios, Bluetooth radios, Zigbee radios, near field communication (NFC) radios, and/or other wireless radios. The electronic device 104, the media output device 115, the display device 123, the speaker device 127, the server 120, and/or the server 140 may include communications circuitry for communications (e.g., directly or via network 106) with audio output device 150 and/or with the others of the electronic device 104, the media output device 115, the display device 123, the speaker device 127, the server 120, and/or the server 140, the communications circuitry including, for example, one or more wireless interfaces, such as WLAN radios, cellular radios, Bluetooth radios, Zigbee radios, near field communication (NFC) radios, and/or other wireless radios.

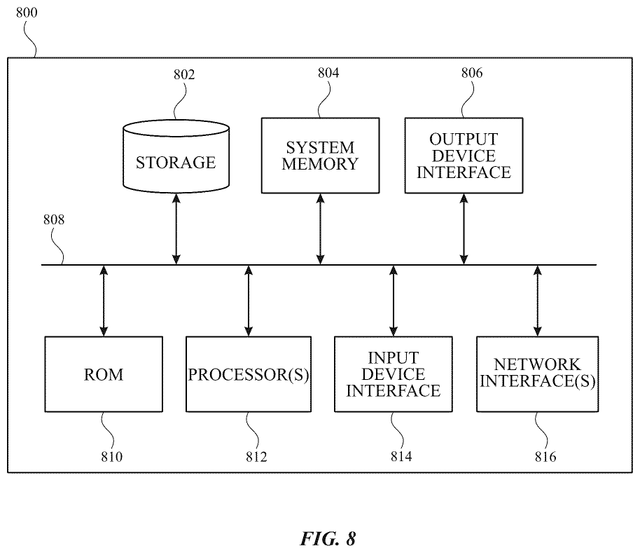

The electronic device 104 may be, for example, a smartphone, a portable computing device such as a laptop computer, a peripheral device (e.g., a digital camera, headphones, another audio device, or another audio output device), a tablet device, a wearable device such as a smart watch, a smart band, a head wearable device, and the like, any other appropriate device that includes, for example, processing circuitry and/or communications circuitry for providing audio content to audio output device(s) 150, for receiving audio inputs from the audio output device(s) 150, and/or for providing audio inputs received at the electronic device 104 and/or the audio output device(s) 150 to the media output device 115. In FIG. 1, by way of example, the electronic device 104 is depicted as a mobile smartphone device. In one or more implementations, the electronic device 104 and/or the audio output device 150 may be, and/or may include all or part of, the electronic device discussed below with respect to the electronic system discussed below with respect to FIG. 8.

As shown in FIG. 1, the electronic device 104 may including processing circuitry 170, one or more speakers 172 (e.g., and/or one or more other audio output components including other speakers), one or more microphones 174, and/or other components (e.g., memory, displays, batteries, etc.), which may be disposed within and/or otherwise mounted to a housing of the electronic device 104. As shown in FIG. 1, the audio output device 150 may include a housing that is physically separate from the housing of the electronic device, and the speaker(s) 151 and/or the microphones 152 (e.g., and/or other components such as memory, processor(s), communications circuitry, or the like) may be disposed within or otherwise mounted to the housing of the audio output device 150.

As shown in FIG. 1, the display device 123 may include one or more speakers 119 and/or a display 121. In one or more implementations, the display 121 may be operable to display lyrics to a song while at least a music portion (e.g., with or without an original singer) of the song is output by the speaker(s) 119 and/or the speaker device 127 (e.g., responsive to receiving corresponding audio content from the media output device 115). In the example of FIG. 1, the display device 123 is connected to the media output device 115 by a wired connection (e.g., an HDMI or other wired connection). However, in other implementations, display device 123 may be connected to the media output device 115 via a wireless connection (e.g., via the network 106 or directly). In one or more implementations, the speaker device 127 may output music received via the display device 123, or directly, from the electronic device 104 and/or the media output device 115 (e.g., while corresponding lyrics are displayed on the display 121 of the display device 123 or by the display 162 of the electronic device 104. In one or more implementations, the display 162 of the electronic device 104 and/or the display 121 of the display device 123 may display a user interface element configured to allow a user to control an amount of an original singer's voice that is included in the output of the music from the speaker 151, the speaker 119, the speaker 172, and/or the speaker device 127.

In one or more implementations, the electronic device 104 and/or the media output device 115 may include memory (e.g., volatile or non-volatile memory) that stores audio content, such as a music library containing one or more audio files, each corresponding to a song or other rhythmic audio content. For example, songs stored in the memory may have been downloaded from a remote service (e.g., a first remote service 130 hosted by the server(s) 120 or a second remote service (e.g., a second remote service 160 hosted by the server(s) 140), or uploaded to the memory from another electronic device or storage medium.

In one or more implementations, the electronic device 104 and/or the media output device 115 may include one or more applications, such as media player applications or media service applications (e.g., each associated with a remote service, such as the first remote service 130 or the second remote service 160), fitness applications that can be used to play audio content during a workout or activity, or any other application that can be used to output audio content.

In one or more implementations, the electronic device 104 and/or the media output device 115 may stream audio content from one or more remote services, such as the first remote service 130 and the second remote service 160 of FIG. 1. In one or more implementations, the first remote service 130 and the second remote service 160 may each be accessible via a corresponding application installed on the electronic device 104. Examples of remote services that can provide streaming music via an application at the electronic device include, but are not limited to, Pandora®, Apple Music®, Spotify®, Tidal®, Amazon Music®, and YouTube Music®. In one or more implementations, audio content may be obtained by the electronic device 104 and/or the media output device 115 from the first remote service 130, the second remote service 160, any other remote service, and/or local memory, and output using the speaker(s) 172 of the electronic device 104, the speaker(s) 119 of the display device 123, the speaker device 127, the audio output device 150, and/or any other speaker that is communicatively coupled to the electronic device 104 and/or the media output device 115.

The server(s) 120 may form all or part of a network of computers or a group of servers for the first remote service 130, such as in a cloud computing or data center implementation. For example, the server(s) 120 may store data (e.g., audio content) and software, and include specific hardware (e.g., processors, graphics processors and other specialized or custom processors) storing, curating, and/or streaming audio content to network-connected devices, such as the electronic device 104. The server(s) 140 may form all or part of a network of computers or a group of servers for the second remote service 160, such as in a cloud computing or data center implementation. For example, the server(s) 140 may store data (e.g., audio content) and software, and include specific hardware (e.g., processors, graphics processors and other specialized or custom processors) storing, curating, and/or streaming audio content to network-connected devices, such as the electronic device 104.

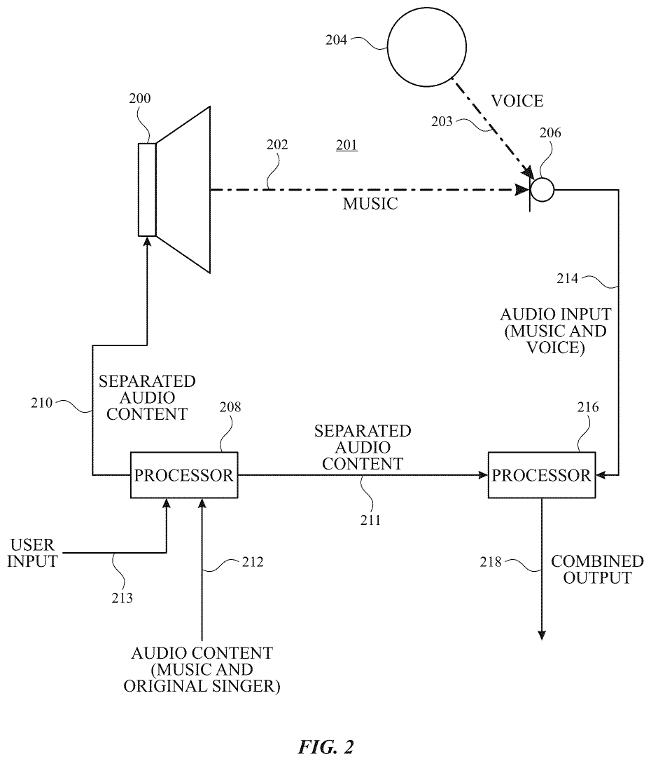

FIG. 2 illustrates aspects of an example use case in which music 202 is output by a speaker 200. In one or more implementations, the music may be a music portion of audio content 212 that includes the music and one or more voices of one or more original singers. For example, the audio content 212 may be digital audio content. The music and the one or more voices of the one or more original singers may have been previously recorded and stored, in the form of the audio content 212, at one or more electronic devices and/or servers. As examples, the music may include instrumental music generated by one or more real and/or synthesized musical instruments (e.g., pianos, keyboards, guitars, violins, bass guitars, drums, or any other musical instrument). The music may also include one or more voices of one or more original backup singers in some use cases. The one or more voices of the one or more original singers may include a voice of a lead singer or multiple voices of multiple lead singers (e.g., in the case of a duct or other group in which two or more singers take turns singing alone and/or sing together, such as in harmony).

As shown, the audio content 212 including the music and the one or more original singers may be provided to a processor, such as processor 208. As examples, processor 208 may be a processor of the electronic device 104 or the media output device 115. As discussed in further detail hereinafter, the processor 208 may separate a portion of the audio content corresponding to the music from a portion of the audio content corresponding to the one or more original singers of the music. As shown, the processor 208 may provide separated audio content 210 to the speaker 200. For example, the separated audio content 210 may include only portion of the audio content corresponding to the music.

FIG. 2 also shows a processor 216. As examples, the processor 216 may be a processor of the electronic device 104 or the media output device 115. In various implementations, the processor 216 and the processor 208 may be disposed in the same electronic device (e.g., within a common housing) or may be processors of two different electronic devices (e.g., and housed within two physically separate housings). The processor 208 and the processor 216 may be different processors or may be the same processor or processors of the same system-on-chip.

In one or more implementations, the separated audio content 210 may also include a modified amount of the audio content corresponding to the one or more original singers of the music. For example, the processor may include an amount of the audio content corresponding to the one or more original singers of the music ranging from zero to one hundred percent, such as according to a user input identifying the amount. In this way, a user of the electronic device 104 or the media output device 115 may be provided with the ability to turn up or down the original singer's voice in the output of the speaker 200, such as while the user sings along to the music 202. In various implementations, the speaker 200 may be a speaker 172 of the electronic device 104, a speaker 119 of a display device 123, or a speaker of a speaker device 127.

As shown in FIG. 2, a person 204 (e.g., a user of the electronic device 104 or the media output device 115, such as the user 101 of FIG. 1) may sing along with the music 202 that is output by the speaker 200. As shown, while singing, a voice 203 of the person 204 may be received by one or more microphones, such as microphone 206, along with the music 202. In one or more use cases, ambient noise and/or other sounds from the physical environment 201 within which the speaker 200 and the microphone 206 are disposed may also be received by the microphone 206. In various implementations, the microphone 206 may be a microphone of the electronic device 104. In one or more implementations, one or more additional microphones (e.g., microphones 152 of the audio output device 150) may also capture the voice 203 of the person 204 and the music 202 output by the speaker 200.

As shown, a microphone signal 214 (or a processed audio signal generated based on the microphone signal 214) may be provided, as an audio input stream, to a processor, such as processor 216. The microphone signal 214 may include the voice 203 of the person 204 and the music 202 output from the speaker 200 (e.g., and sound from any other sources of sound in the physical environment).

As shown in FIG. 2, separated audio content 211 may be provided from the processor 208 to the processor 216. For example, the separated audio content 211 may include only the portion of the audio content corresponding to the music or may include, separately (e.g., in separate audio channels), the portion of the audio content corresponding to the music and the portion of the audio content corresponding to the one or more original singers of the music. As shown, the processor 216 may generate, based on the audio input stream (e.g., the microphone signal 214) and the separated audio content 211, a combined output 218. For example, the combined output 218 may include the portion of the audio content corresponding to the music and a portion of the microphone signal 214 corresponding to the voice 203 of the person 204. In this way, the person 204 can be recorded as though singing along with the original (e.g., digital) audio content 212 corresponding to the music, even though the voice 203 of the person 204 was recorded together with a speaker output of the same audio content.

For example, the processor 216 may separate the voice 203 of the person 204 in the audio input stream (e.g., the microphone signal 214) from the music 202 in the audio input stream (e.g., the microphone signal 214) to generate a voice stream including (e.g., only) the voice 203 of the person 204. The processor 216 may also obtain the separated audio content 211 corresponding to the music 202 (e.g., upon which the output of the music 202 was based) from the processor 208 (e.g., and/or by generating the separated audio content 211 from the audio content 212 locally at the processor 216), and may combining the voice stream with the audio content corresponding to the music to generate the combined output 218. The combined output 218 may then be provided for storage or playback.

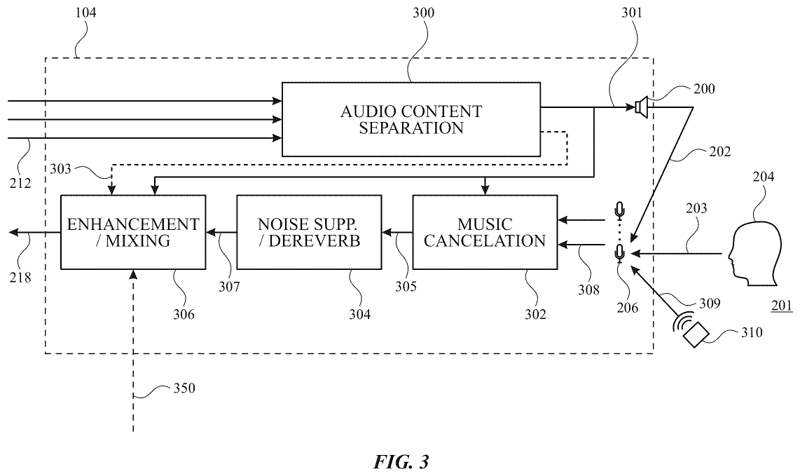

FIG. 3 illustrates an example implementation in which the speaker 200, the microphone 206, and the processor(s) (e.g., processor 208 and/or processor 216) that perform the operations described in connection with FIG. 2 are implemented in the same device. As shown in FIG. 3, the audio content 212 may be provided to an audio content separation block 300 at the electronic device 104. The audio content separation block 300 may be implemented as a digital signal processor configured to separate a voice portion 303 of audio content 212 from a music portion 301 (e.g., separated audio content 210 of FIG. 2) of the audio content 212, or as a machine learning model trained to separate the voice portion 303 of the audio content 212 from the music portion 301 of the audio content 212 (as examples).

As shown, the music portion 301 may be provided to the speaker 200 (e.g., an implementation of the speaker 172 of FIG. 1) of the electronic device 104 for output into the physical environment 201 (e.g., such that the output of the speaker 200 is audible by the person 204 and by one or more microphones 206 of the electronic device 104). As shown, the music portion 301 may also be provided to one or more other processing blocks at the electronic device 104, such as a music cancelation block 302, a noise suppression and/or dereverberation block 304, and/or an enhancement and/or mixing block 306.

As shown in FIG. 3, the music 202 output by the speaker 200 of the electronic device 104 based on the music portion 301 of the audio content 212 may be received by one or more microphones 206 (e.g., implementation of the microphone 174 of FIG. 1) of the electronic device 104. As shown, the person 204 may sing along with the music 202, and the voice 203 of the person 204 may also be received by the one or more microphones 206 of the electronic device 104, along with the music 202 output by the speaker 200. As shown, the microphones 206 may also receive sound 309 from a noise source 310 in the physical environment 201. The noise source 310 may include one or more other people talking, one or more vehicles, one or more appliances and/or any other sources of sound that can be present in a physical environment.

As shown, an audio input stream 308 generated by the microphone(s) 206 may be provided to the music cancelation block 302. The music cancelation block 302 may cancel (e.g., based on the music portion 301 of the audio content 212 received from the audio content separation block 300) a portion of the audio input stream 308 from the microphone(s) 206 that corresponds to the music 202, to generate a voice stream 305. In one or more implementations, canceling the portion of the audio input stream 308 that corresponds to the music 202 may include detecting the music portion of the audio input stream 308 (and/or a voice portion of the audio input stream 308) using, for example, pattern recognition operations performed during music playback from the speaker 200. For example, the music cancelation block 302 may be programmed and/or trained to detect patterns in the audio input stream 308 that correspond to the music 202 or the voice 203 based on spectral and/or temporal markers in the music portion 301 of the audio content 212, based on a recognition of a known voice of the user of the electronic device 104, and/or based on a speech-to-text correlation between the audio input stream 308 and lyrics that are known to the electronic device 104 from the audio content 212. Once the voice portion and/or the music portion of the audio input stream 308 have been detected, the music cancelation block 302 may cancel or otherwise remove the music portion of the audio input stream 308 from the audio input stream 308 to generate a voice stream 305 (e.g., containing only the voice 203 of the person 204 and without the portion of the audio input stream 308 that corresponds to the music 202 output from the speaker 200). The music cancelation block 302 may be implemented as a digital signal processor configured to separate the voice stream 305 from the music 202 in the audio input stream 308, or as a machine learning model trained to separate the voice stream 305 from the music 202 in the audio input stream 308 (as examples).

In one or more implementations, the electronic device 104 may include a noise suppression and/or dereverberation block 304. For example, the noise suppression and/or dereverberation block 304 may perform a noise suppression operation on the voice stream 305 (e.g., to cancel and/or otherwise remove some or all of the sound 309 generated by the noise source 310 that may be present in the voice stream 305). The noise suppression and/or dereverberation block 304 may also, or alternatively, perform a dereverberation operation on the voice stream 305 (e.g., to remove a reverberation, and/or other acoustic room effects generated by the acoustic properties of the physical environment 201, from the voice stream 305). The noise suppression and/or dereverberation block 304 may include a digital signal processor configured to cancel and/or otherwise remove some or all of the sound 309 generated by the noise source 310 that may be present in the voice stream 305, or as a machine learning model trained to cancel and/or otherwise remove some or all of the sound 309 generated by the noise source 310 that may be present in the voice stream 305 (as examples). The noise suppression and/or dereverberation block 304 may include a digital signal processor configured to remove a reverberation, and/or other acoustic room effects generated by the acoustic properties of the physical environment 201, from the voice stream 305, or as a machine learning model trained to remove a reverberation, and/or other acoustic room effects generated by the acoustic properties of the physical environment 201, from the voice stream 305 (as examples).

Following the optional noise suppression and/or dereverberation operations of the noise suppression and/or dereverberation block 304, a voice stream 307 (e.g., the voice stream 305 or a de-noised and/or de-reverbed version of the voice stream 305 having had the noise suppression and/or dereverberation operations performed thereon) may be provided from the noise suppression and/or dereverberation block 304 to an enhancement and/or mixing block 306.

As shown, the enhancement and/or mixing block 306 may receive, in addition to receiving the voice stream 307, the voice portion 303 of audio content 212 and the music portion 301 (of the audio content 212. The enhancement and/or mixing block 306 may perform mixing operations to mix the voice stream 307 with the music portion 301 of the audio content 212 to generate a combined output 218. In one or more implementations, the mixing operations may also include mixing in some or all of the voice portion 303 (e.g., as performed by an original signer or singers) with the voice stream 307 and the music portion 301 to generate the combined output 218. For example, whether the voice portion 303 is mixed into the combined output 218, and/or an amount of the voice portion 303 that is mixed into the combined output 218, may be determined based on a user input to the electronic device 104, the user input indicating whether or how much of the original singer's voice is to be included in the combined output. The enhancement and/or mixing block 306 may include a digital signal processor configured to mix the voice stream 307 with the music portion 301 of the audio content 212 and/or the voice portion 303 of the audio content 212, and/or a machine learning model trained to mix the voice stream 307 with the music portion 301 of the audio content 212 and/or the voice portion 303 of the audio content 212.

In one or more implementations, the enhancement and/or mixing block 306 may also perform one or more enhancement operations on the voice stream 307 prior to mixing the voice stream 307 into the combined output 218. For example, the enhancement operations may include, prior to combining the voice stream 307 with the voice portion 303 of the audio content 212, modifying a style of the voice stream 307. The voice stream 307, with the style having been modified, may then be mixed with the audio content.

For example, modifying the style of the voice stream 307 may include modifying the style based on a style detected by the electronic device 104 in the audio content 212 (e.g., in the music portion 301 and/or the voice portion 303). For example, modifying the style based on the style detected by the electronic device 104 in the audio content 212 may include detecting a reverb style in the audio content 212 and applying the reverb style to the voice stream. Examples of reverb styles may include physical reverb styles, mechanical reverb styles, digital reverb styles, a hall reverb style, a chamber reverb style, a room reverb style, a plate reverb style, a spring reverb style, and/or any other reverb style for reproducing or mimicking reflections of a sound that can be included with that sound in a recording. In this way, in one or more use cases, the noise suppression and/or dereverberation block 304 and the enhancement and/or mixing block 306 may remove a recorded reverberation from a recording of the voice 203 of the person 204, and apply a reverberation obtained from the voice portion 303 of the audio content 212 (e.g., a reverberation of the original singer's voice) to the voice 203 of the person 204 for inclusion in the combined output 218.

In one or more implementations, the enhancement operations may also, or alternatively, include remixing operations, in which a mix of music and voice in the audio content 212 is modified in the combined output 218. For example, the remixing operations may include remixing a portion of the audio content, and combining the voice stream with the audio content with the portion having been remixed. For example, remixing the portion of the audio content may include modifying a first amount of a voice of an original singer of the music in the audio content (e.g., a first amount of the music portion 301 of the audio content 212).

In one or more implementations, the electronic device 104 (e.g., the audio content separation block 300 or another process at the electronic device) may also modify, based on a user input (e.g., user input 213 of FIG. 1) to the electronic device, a second amount of the voice of the original singer of the music in the music 202 that is output from the speaker 200 (e.g., by modifying an amount of the voice portion 303 of the audio content 212 that is output from the speaker 200 with the music portion 301 of the audio content 212). For example, modifying the second amount of the voice of the original singer of the music in the music from the speaker 200 may be performed without affecting the modified first amount of the voice of the original singer of the music in the audio content that is combined with the voice stream. In this way, a person 204, such as the user of the electronic device 104, may be provided with the ability to vary the amount of the original singer's voice that is output from the speaker 200 (e.g., to aid the person 204 in singing along with the music 202) without affecting the amount of the original singer's voice that is included in the combined output 218 (which may be controlled separately by the user).

In one or more implementations, the enhancement and/or mixing block 306 may apply a filter (e.g., an audio filter, such as a low pass filter, a high pass filter, a band pass filter, an all pass filter, and/or any other audio filter) to the voice stream 307 and/or to the combined output 218. In one or more implementations, the filter may be determined, by the enhancement and/or mixing block 306 based on a filter detected in the audio content (e.g., a filter may be obtained and/or generated by the enhancement and/or mixing block 306 that matches a filter detected in the audio content 212). In one or more implementations, the filter may be learned by the electronic device 104, such as by the enhancement and/or mixing block 306. For example, the enhancement and/or mixing block 306 may learn one or more filters that are preferred by a user of the electronic device 104, such as the person 204, based on one or more filters that are used in various songs that are played by the user using the electronic device, and/or based on one or more filters that have been previously selected by the user.

As illustrated in FIG. 3, in one or more use cases, the enhancement and/or mixing block 306 may also mix one or more voice streams, such as another voice stream 350 corresponding to one or more other people, into the combined output 218 (e.g., with the voice stream 307, the music portion 301 of the audio content 212, and, optionally, some or all of the voice portion 303 of the audio content 212). For example, the person 204 in the physical environment 201 may desire to record a duet with another person in another physical environment that is remote from the physical environment 201. In one or more implementations, the music portion 301 of the audio content 212 may also be output by a speaker of a device of the other person in the other physical environment, and one or more microphones of the device of the other person may generate another audio input stream containing the voice of the other person singing along with the music being output by the other person's own device.

In one or more implementations, the other electronic device may perform music cancelation operations, noise suppression operations, dereverberation operations, and/or enhancement operations, as described herein, on the other audio input stream locally at the other electronic device to generate the other voice stream 350, and may provide the other voice stream 350 to the enhancement and/or mixing block 306 for mixing with the voice stream 307 and the music portion 301 of the audio content 212.

In one or more other implementations, the other device may provide the other audio input stream (e.g., wirelessly) to the electronic device 104, and the electronic device 104 may then perform the music cancelation operations, noise suppression operations, dereverberation operations, and/or enhancement operations on the other audio input stream before combining another voice stream 350, obtained locally from the other audio input stream, with the voice stream 307 and the music portion 301 of the audio content 212.

The enhancement and/or mixing block 306 may include a digital signal processor configured to perform enhancement, remixing, and/or spatialization operations as described herein, and/or a machine learning model trained to perform enhancement, remixing, and/or spatialization operations as described herein (as examples). In various implementations, the audio content separation block 300, the music cancelation block 302, the noise suppression and/or dereverberation block 304, and/or the enhancement and/or mixing block 306 may be implemented in software or hardware, including by one or more processors and a memory device containing instructions, which when executed by the processor cause the processor to perform the operations described herein. For example, in one or more implementations, any of all of the audio content separation block 300, the music cancelation block 302, the noise suppression and/or dereverberation block 304, and/or the enhancement and/or mixing block 306 may be executed by the processor 208 and/or the processor 216 of FIG. 2.

In the example of FIG. 3, the microphones 206, the speaker 200, the audio content separation block 300, the music cancelation block 302, the noise suppression and/or dereverberation block 304, and the enhancement and/or mixing block 306 are disposed in and/or executed at the electronic device 104. In one or more other implementations, the microphones 206, the speaker 200, the audio content separation block 300, the music cancelation block 302, the noise suppression and/or dereverberation block 304, and the enhancement and/or mixing block 306 may be distributed across two or more devices.

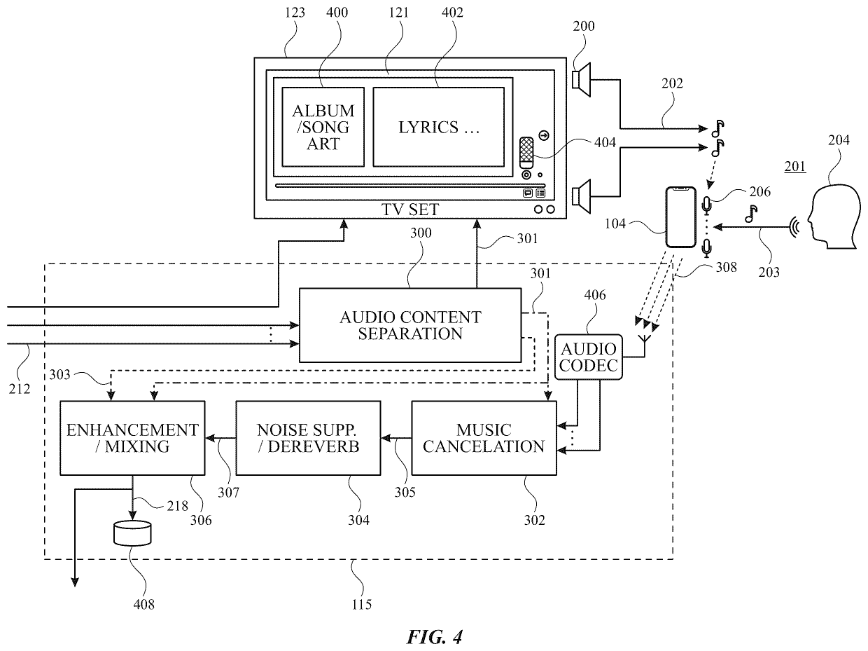

For example, FIG. 4 illustrates an implementation in which the speaker 200 is disposed in and/or controlled by the display device 123, the microphone(s) 206 are disposed in the electronic device 104, and the audio content separation block 300, the music cancelation block 302, the noise suppression and/or dereverberation block 304, and the enhancement and/or mixing block 306 are disposed in and/or executed by the media output device 115. For example, the arrangement of FIG. 4 may be desirable to provide a larger display, such as display 121 (e.g., for display of album and/or song art 400 corresponding to a song being output by the speaker(s) 200, and/or real-time display of lyrics 402) than is available on the electronic device 104 (though the album and/or song art 400 and/or the lyrics 402 may also be displayed by the display 162 of the electronic device 104), and/or to provide louder and/or higher quality output of the music 202 (e.g., from speakers 200 that are larger than would be available in the electronic device 104). As shown in FIG. 4, the display 121 of the display device 123 may also display a slider 404 that is controllable by a user, such as the person 204, to control (e.g., via control signals to the audio content separation block 300) the amount of the original singer's voice (e.g., the voice portion 303 of the audio content 212) that is output by the speaker 200 (e.g., from none to all of the original singer's voice)

In this example, the music 202 and the voice 203 of the person 204 are received by the microphone(s) 206 of the electronic device 104, and the electronic device 104 provides the resulting audio input stream 308 (e.g., wirelessly) to the media output device 115 (e.g., which may not include any microphones or any speakers in some implementations). In this example, the audio input stream 308 may be encoded by the electronic device 104 for transmission to the media output device 115, and may be decoded by an audio codec 406 at the media output device 115 before being provided to the music cancelation block 302 at the media output device 115.

In this example, the audio content 212 is received at the media output device 115 (e.g., from local memory, from the electronic device 104, from the servers 120 and/or from the servers 140). As shown, the audio content separation block 300 at the media output device 115 may separate the voice portion 303 of the audio content 212 from the music portion 301 of the audio content 212. As shown, the music portion 301 may be provided to the display device 123 for output by the speaker(s) 200 of the display device 123 into the physical environment 201 (e.g., such that the output of the speaker 200 is audible by the person 204 and one or more microphones 206 of the electronic device 104). As shown, the music portion 301 may also be provided to one or more other processing blocks at the media output device 115, such as the music cancelation block 302, the noise suppression and/or dereverberation block 304, and/or the enhancement and/or mixing block 306. In the example of FIG. 4, the combined output 218 generated by the enhancement and/or mixing block 306 may be provided for storage, such as in memory 408 of the media output device 115. As shown, the combined output 218 may also be provided from the media output device 115 externally from the media output device 115, such as to one or more other devices or servers, such as for storage and/or playback.

In the examples of FIGS. 2-4, the combined output 218 has been described as being provided for storage and/or (e.g., later) playback. Output of the combined output 218, such as by the speaker 200, into the physical environment 201 in which the microphones 206 are disposed may be undesirable, due to potential feedback distortion issues in the output of the speaker 200. However, it may still be desirable to be able to provide some form of the combined output to the person 204, such as for real-time feedback to help the person 204 with their singing.

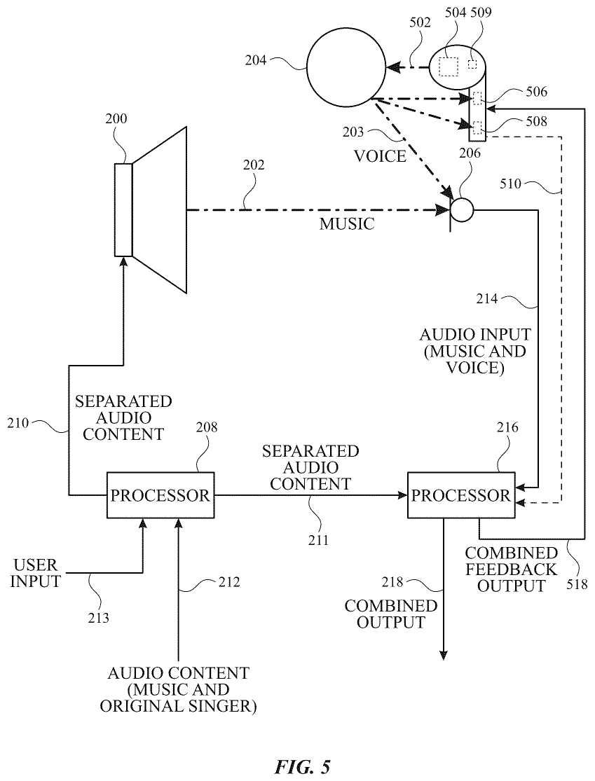

FIG. 5 illustrates an example in which real-time feedback can be provided to the person 204. In the example of FIG. 5, as in the example of FIG. 2, a processor 208 and a processor 216 are shown. As examples, the processor 216 may be a processor of the electronic device 104 or the media output device 115. In various implementations, the processor 216 and the processor 208 may be disposed in the same electronic device (e.g., within a common housing) or may be processors of two different electronic devices (e.g., and housing within two physically separate housings). The processor 208 and the processor 216 may be different processors or may be the same processor or processors of the same system-on-chip.

As shown in FIG. 5, in addition to, or alternatively to, the combined output 218 that is provided for storage and/or playback, in one or more implementations, a combined feedback output 518 may be provided to an audio output device, such as audio output device 150 (e.g., a headphone or an earbud) that has a speaker 504 (e.g., an implementation of the speaker 151 of FIG. 1) that outputs sound 502 directly to the ear of the person 204 (e.g., and not into the physical environment 201). In this example, the combined feedback output 518 may be output by the speaker 504 of the audio output device 150 for real-time playback during the obtaining of the microphone signal 214 (e.g., using the microphone 206). Because the combined feedback output 518 includes the person's own voice 203, the combined feedback output 518 may be helpful to the person 204 to sing along with the music 202. In one or more implementations, the user's own voice may be enhanced and/or spatialized in the combined feedback output 518, to further support the person's ability to sing along with the music 202. In the example of FIG. 5, a single earbud is depicted for simplicity. However, it is appreciated that two earbuds or two headphones, each with one or more speakers and one or more microphones may perform parallel operations to those described herein in connection with the audio output device 150.

For example, the processor 216 (e.g., running the music cancelation block 302, the noise suppression and/or dereverberation block 304, and/or the enhancement and/or mixing block 306) may combine a first amount of the voice stream 307 of FIGS. 3 and 4 with the music portion 301 of the audio content 212 to form the combined output 218 as described herein in connection with FIGS. 2-4. The processor 216 (e.g., running the music cancelation block 302, the noise suppression and/or dereverberation block 304, and/or the enhancement and/or mixing block 306) may also (or alternatively) combine a second amount of the voice stream 307, different from the first amount of the voice stream 307, with the music portion 301 of the audio content 212 to generate the combined feedback output 518. For example, the second amount of the voice stream 307 in the combined feedback output 518 may be greater than the first amount of the voice stream 307 in the combined output 218 (e.g., to amplify the user's own voice 203), to facilitate the person 204 hearing their own voice 203 (e.g., over the music 202 playing from the speaker 200) during the obtaining of the microphone signal 214 (e.g., 308) using the microphone(s) 206.

As shown in FIG. 5, in one or more implementations, one or more microphones, such as a microphone 506 and a microphone 508 (e.g., implementations of the microphone(s) 152 of FIG. 1), of the audio output device 150 may capture an additional audio input stream 510 including the voice 203 of the person 204. In one or more implementations, one or more other sensors 509 (e.g., one or more accelerometers or other vibration detectors that can detect the person's own voice via bone conduction of the voice, or other conduction of the voice of the person through the person's own head) may also generate a portion of the audio input stream corresponding to the voice 203. The microphones 506 and 508 of the audio output device 150 may also capture some of the music 202 from the speaker 200. The audio output device 150 may generate an additional audio input stream 510 based on the microphone signals from the microphone 506 and/or the microphone 508, and/or based on a sensor signal from the sensor(s) 509.

As shown, the audio output device 150 may provide the additional audio input stream 510 to the processor 216, such as for processing (e.g., by the music cancelation block 302, the noise suppression and/or dereverberation block 304, and/or the enhancement and/or mixing block 306 running on the processor 216 as described herein in connection with the audio input stream 308) along with the microphone signal 214 from the microphone 206. Because the audio output device 150 may be worn by the person 204 on the person's head, the microphone 506, the microphone 508, and/or the sensor(s) 509 may be disposed near to the mouth of the person 204 while the person 204 sings along with the music 202. Accordingly, the additional audio input stream 510 may be helpful in identifying the voice 203 of the person 204 in the microphone signal 214 and/or the additional audio input stream 510, for separation from the output of the music 202 (e.g., by the music cancelation block 302 running on the processor 216).

Because the user's voice 203 may be captured by multiple microphones (e.g., one or more microphones 206 and/or the microphone 506 and/or 508 of the audio output device 150), and/or the sensor(s) 509, a spatial distribution of the voice 203 of the person 204 in the audio input stream(s) may be identifiable by the processor 216 (e.g., by the music cancelation block 302 running on the processor 216). This spatial voice information provided by the microphones 506 and 508 and/or the sensor(s) 509, may help to facilitate modifying a spatial distribution of the voice stream 307 corresponding to the user's voice 203 in the combined output 218 and/or the combined feedback output 518. For example, the voice stream 307 corresponding to the user's voice 203 in the combined feedback output 518 may be spatialized in a way that, when the combined feedback output 518 is output by the speaker(s) 504 of the audio output device(s) 150, moves the perceived location of the origination of the user's voice away from the location(s) of the microphone(s) 206 and/or the microphones 506 and 508, to another location. As examples, the other location may be the location of the mouth of the person 204, or another location within the physical environment 201 such as the location of the speaker 200 (e.g., so that the person's own voice is perceived by the person as emanating from the speaker 200 together with the music 202, even though the speaker 200 does not output the person's own voice).

As another example, the voice stream 307 corresponding to the user's voice 203 (e.g., a sidetone stream) in the combined feedback output 518 may be spatialized in a way that counters the person's perception of their own voice as coming, partially, from within their own head. For example, the combined feedback output 518 may include a spatialized version of the voice 203 of the person 204 that includes a portion that cancels the person's own perception of their own voice from within their head, and another portion that spatializes the perceived location of the voice 203 of the person 204 to a location outside of the person's head (e.g., to the location of the person's mouth, or to a location remote from the person within the physical environment 201, such as the location of the speaker 200 or any other location).

In one or more implementations, the processor 216 (e.g., the enhancement and/or mixing block 306 running on the processor 216) may modify an original spatial distribution of the voice stream 307 to an updated spatial distribution of the voice stream 307 in the combined feedback output 518 (e.g., which may be different from a spatial distribution of the voice stream 307 in the combined output 218). For example, the original spatial distribution of the voice stream 307 may be based on a location of the microphone(s) 206 of the electronic device 104 (e.g., and/or the location(s) of the microphones 506 and 508 of the audio output device 150) relative to a mouth of the person 204, and the updated spatial distribution of the voice stream 307 may be independent of the location of the microphone(s) 206 of the electronic device 104 (e.g., and/or the location(s) of the microphones 506 and 508 of the audio output device 150). For example, the updated spatial distribution of the voice stream 307 may be configured to, when output by the speaker(s) 504 of the audio output device 150 (e.g., multiple speakers of two headphones or two earbuds worn by the person 204), be perceived (e.g., by the person 204) as originating from a mouth of the person 204. As another example, the updated spatial distribution of the voice stream 307 may be configured to, when output by the speaker(s) 504 of the audio output device 150 (e.g., multiple speakers of two headphones or two earbuds worn by the person 204), be perceived (e.g., by the person 204) as originating from a location in the physical environment 201 that is separate from the location of the microphone(s) 206 and separate from a location of the mouth of the person 204.

In one or more implementations, the processor 216 (e.g., the enhancement and/or mixing block 306 running on the processor 216) may modify the original spatial distribution of the voice stream 307 to the updated spatial distribution of the voice stream 307 in the combined feedback output 518, in part, by generating a portion of the voice stream 307 that is configured to, when output by the speaker(s) 504 of the audio output device 150 (e.g., multiple speakers of two headphones or two earbuds worn by the person 204), cancel a portion of the voice 203 of the person 204 that is transmitted to an ear of the person 204 from within the head of the person 204. In this way, the person 204 may be provided with the ability to hear themselves singing from outside their head, and from within the physical environment 201 (e.g., as if they were in an audience listening to themselves perform).

For example, while the audio output device 150 is outputting the combined feedback output 518 including the voice stream 307, the perception of the person 204 of their own voice may include (i) a first portion detected with the microphone(s) 206 of the electronic device 104, and/or the microphones 506 and 508 of the audio output device 150, and output by the speaker(s) 504, and (ii) the physical manifestation of sound generated by the vocal chords of the user and transmitted internally to the ear of the person 204 from within the head of the person 204. In one or more implementations, the processor 216 (e.g., the enhancement and/or mixing block 306 running on the processor 216) may generate (e.g., using a machine learning model trained to generate an in-the-head cancellation signal for a person 204 based on a voice stream, such as voice stream 307, including the voice 203 of the person). This in-the-head cancellation signal can be included in the combined feedback output 518 to cancel the physical manifestation of sound generated by the vocal chords of the user and transmitted internally to the ear of the person 204 from within the head of the person 204, and allow the person to hear themselves from outside of their head.

In one or more implementations, a voice activity detector operating at the audio output device 150, utilizing sensor(s) 509 and/or microphones 506 and/or 508 at the audio output device 150, may detect that the person 204 is singing (e.g., along with the music 202), and trigger the processor 216 (e.g., at the audio output device 150, the electronic device 104, or the media output device 115) to enhance the spatial playback of the person's own voice during reproduction on the same audio output device 150. In one or more implementations, singing detection by the audio output device 150 may be achieved using pattern recognition during music playback on the audio output device 150. For example, patterns that may be detected for singing detection may include spectral and/or temporal markers that are detected in the audio content 212 and the captured voice 203. As another example, patterns that may be detected for singing detection may include correlations between text generated from the captured voice 203 in a speech-to-text conversion and published music lyrics from the audio content 212. As discussed herein, singing enhancement of the person's own voice in the combined feedback output 518 may be generated utilizing computational acoustics and principles of spatial audio to improve own-voice imaging and dynamics (including reverb) to improve the sing-along experience.

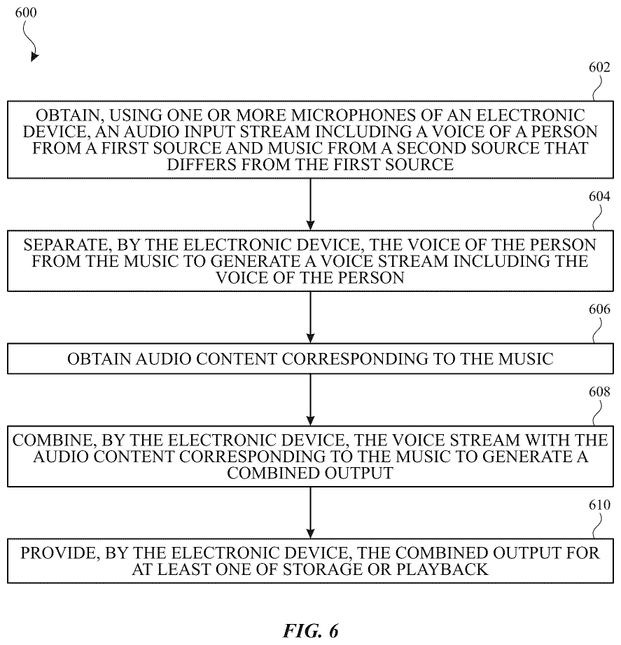

FIG. 6 illustrates a flow diagram of an example process 600 for operating an electronic device, in accordance with implementations of the subject technology. For explanatory purposes, the process 600 is primarily described herein with reference to the electronic device 104 of FIG. 1. However, the process 600 is not limited to the electronic device 104 of FIG. 1, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, an electronic device (e.g., electronic device 104) may obtain, using one or more microphones (e.g., one or more microphones 206, and/or one or more other microphones), an audio input stream (e.g., microphone signal 214) that includes a voice (e.g., a voice 203) of a person (e.g., a person 204) from a first source (e.g., from a mouth of the person), and music (e.g., music 202) from a second source (e.g., speaker 200) that differs from the first source. For example, the second source may include a speaker (e.g., speaker 200) of the electronic device, and the process 600 may also include outputting the music with the speaker by operating the speaker based on the audio content.

Operating the speaker based on the audio content may include separating, by the electronic device (e.g., by the audio content separation block 300 running on processor 208), a portion (e.g., music portion 301) of the audio content corresponding to the music and a portion (e.g., voice portion 303) of the audio content corresponding to an original singer of the music, and operating the speaker, based on the portion of the audio content corresponding to the music (e.g., to output the music 202 without the original singer, or with a reduced amount of the original singer). In one or more implementations, the electronic device may operate the speaker based on the portion of the audio content corresponding to the original singer of the music, to output a user-controllable amount of the original singer of the music.

In one or more implementations, the first source may include the person, and the second source may include a speaker of another electronic device (e.g., a wireless speaker such as speaker device 127, a display device 123 such as a television, a smart speaker, or any other device having a speaker and being communicatively coupled with the electronic device).

At block 604, the electronic device (e.g., music cancelation block 302, running on processor 216), may separate the voice of the person from the music to generate a voice stream (e.g., voice stream 305 or voice stream 307) including the voice of the person. For example, the electronic device may receive a music portion of the audio content, and may cancel (e.g., using the music portion of the audio content as a guide to identify the music portion of the audio input stream) a music portion of the audio input stream to generate the voice stream. In one or more other implementations, the electronic device may detect a voice portion of the audio input stream and generate the voice stream by reproducing only the voice portion of the audio input stream. In one or more implementations, an additional audio input stream (e.g., generated using one or more sensors, such as sensor(s) 509 and/or one or more microphones, such as microphones 506 and microphones 508 of an audio output device 150 worn by the person) may be obtained by the electronic device and used to generate the voice stream. For example, the voice stream may include only the voice of the person, without the music generated by the second source.

At block 606, the electronic device (e.g., audio content separation block 300 running on processor 208) may obtain audio content (e.g., audio content 212, such as digital audio content) corresponding to the music (e.g., digital audio content that stores an encoded representation of the music). For example, the audio content may be obtained from storage at the electronic device. As another example, the audio content may be obtained by streaming the audio content from a remote source, such a server (e.g., servers 120 and/or servers 140).

At block 608, the electronic device (e.g., the enhancement and/or mixing block 306 running on the processor 216) may combine the voice stream with the (e.g., digital) audio content corresponding to the music to generate a combined output (e.g., a combined output 218). In one or more implementations, combining the voice stream with the audio content may include synchronizing the voice stream, in time, with the audio content. For example, synchronizing the voice stream, in time, with the audio content may include matching words or other patterns detected in the voice stream with lyrics or other patterns that are included in the audio content. In one or more implementations, combining the voice stream with the audio content may also include modifying a pitch or frequency of the person's voice in the voice stream, to match the pitch or frequency of the voice of the original signer or of a melody of the music, as determined from the audio content.

In one or more implementations, combining the voice stream with the audio content may include modifying a style of the voice stream, and combining the voice stream, with the style having been modified, with the audio content. For example, modifying the style of the voice stream may include modifying the style based on a style detected by the electronic device in the audio content. For example, the electronic device may include one or more machine learning models that are trained to transfer or transform the voice of the person in the voice stream to match the style of voice of the original signer. In one or more implementations, the electronic device or another electronic device may provide a visualization indicating the pitch of the voice stream relative to the pitch of the original signer (or of a melody of the music). For example, a pitch tracking process can be run on both the voice stream and original vocal(s) in the audio content, and the visualization may include running plot a difference or error in the outputs of the two pitch tracking processes. In this way, the person can be provided with a visual guide, while singing, as to whether their voice is “too low” or “too high” with respect to the audio content e.g., to help improve their singing.

As another example, modifying the style based on the style detected by the electronic device in the audio content may include detecting a reverb style in the audio content, and applying the reverb style to the voice stream. For example, detecting the reverb style in the audio content and applying the reverb style to the voice stream may include estimating the reverb style of the audio content (e.g., based on a reverb flag provided in the audio content or using a machine-learning model that has been trained to estimate the reverb style of the audio content), and using a nearest-neighbor fit on the voice stream when mixing the voice stream with the audio content.

In one or more implementations, combining the voice stream with the audio content may include remixing a portion of the audio content, and combining the voice stream with the audio content with the portion having been remixed. For example, remixing the portion of the audio content may include modifying a first amount of a voice of an original singer of the music in the audio content (e.g., by reducing the amount of the voice of the original singer or removing the voice of the original singer from the combined output).

In one or more implementations, the electronic device may also modify, based on a user input to the electronic device, a second amount of the voice of the original singer of the music in the music from the second source (e.g., by reducing the amount of the voice of the original singer or removing the voice of the original singer from the output from the speaker). For example, modifying the second amount of the voice of the original singer of the music in the music from the second source may include modifying the second amount of the voice of the original singer of the music in the music from the second source without affecting the modified first amount of the voice of the original singer of the music in the audio content that is combined with the voice stream. In one or more implementations, the electronic device (e.g., the enhancement and/or mixing block 306 running on the processor 216) may also apply a filter, learned by the electronic device (e.g., based on the audio content and/or prior user selections), to the combined output.

In one or more implementations, the electronic device (e.g., the noise suppression and/or dereverberation block 304) may perform a noise suppression operation and/or a dereverberation operation on the voice stream prior to combining the voice stream with the audio content.

At block 610, the electronic device (e.g., the enhancement and/or mixing block 306 running on the processor 216) may provide the combined output for at least one of: storage or playback. In one or more implementations, providing the combined output for at least one of storage or playback may include providing a first combined output (e.g., combined output 218) for storage (e.g., and/or later playback at a later time), and providing a second combined output (e.g., combined feedback output) for real-time playback by a personal audio device (e.g., audio output device 150) during the obtaining of the audio input stream (e.g., by the one or more microphones). For example, the personal audio device may include an earbud or headphones having a speaker (e.g., or multiple speakers) that provides a speaker output directly to an ear of the person (e.g., without projecting the speaker output into a physical environment in which the one or more microphones are disposed and can detect the speaker output).

For example, providing the first combined output for storage may include combining a first amount of the voice stream with the audio content, and providing the second combined output for real-time playback may include combining a second amount of the voice stream, different from the first amount of the voice stream, with the audio content. For example, the second amount may be greater than the first amount to facilitate the person hearing their own voice during the obtaining of the audio input stream.

In one or more implementations, providing the second combined output for real-time playback may also, or alternatively, include modifying an original spatial distribution of the voice stream to an updated spatial distribution of the voice stream in the second combined output. For example, the original spatial distribution of the voice stream may be based on a location of the one or more microphones of the electronic device relative to a mouth of the person, and the updated spatial distribution of the voice stream may be independent of the location of the one or more microphones. For example, the updated spatial distribution of the voice stream may be configured to, when output by a plurality of speakers (e.g., speakers 504) of an audio output device (e.g., two or more earbuds or headphones), be perceived as originating from a mouth of the person. As another example, the updated spatial distribution of the voice stream may be configured to, when output by a plurality of speakers (e.g., speakers 504) of an audio output device (e.g., two or more earbuds or headphones), be perceived as originating from a location separate from the location of the one or more microphones and separate from a location of a mouth of the person. In one or more implementations, modifying the original spatial distribution may include generating a portion of the voice stream that is configured to, when output by a plurality of speakers (e.g., speakers 504) of an audio output device (e.g., two or more earbuds or headphones), cancel a portion of the voice of the person that is transmitted to an ear of the person from within the head of the person.

In one or more implementations, the electronic device may also receive, from another electronic device, an additional voice stream (e.g., voice stream 350) that includes an additional voice of an additional person. The electronic device (e.g., the enhancement and/or mixing block 306 running on the processor 216) may combine the voice stream and the additional voice stream with the audio content corresponding to the music to generate the combined output (e.g., to allow multiple remote users of multiple electronic devices to record, in real time, themselves singing a song together).

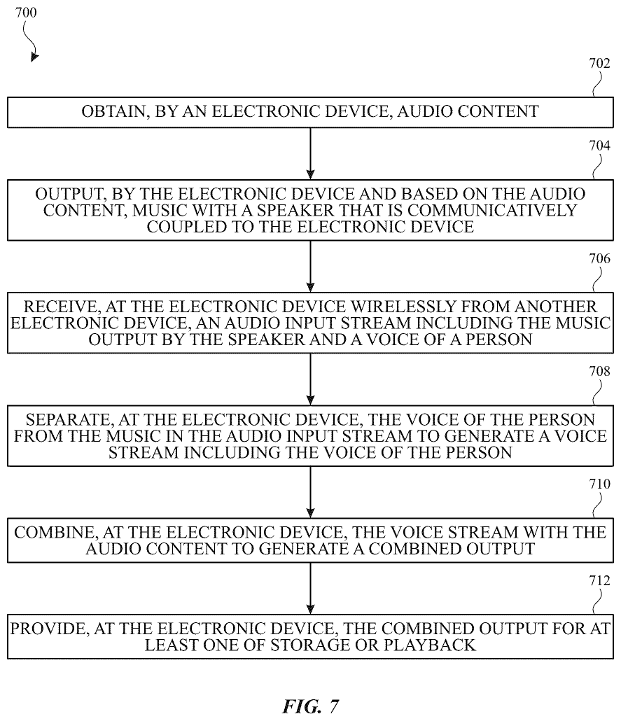

FIG. 7 illustrates a flow diagram of an example process 700 for operating an electronic device in accordance with implementations of the subject technology. For explanatory purposes, the process 700 is primarily described herein with reference to the media output device 115 of FIG. 1. However, the process 700 is not limited to media output device 115 of FIG. 1, and one or more blocks (or operations) of the process 700 may be performed by one or more other components of other suitable devices and/or servers. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In the example of FIG. 7, at block 702, an electronic device (e.g., media output device 115) may obtain audio content (e.g., audio content 212). For example, the audio content may be obtained from storage at the electronic device. As another example, the audio content may be obtained by streaming the audio content from a remote source, such a server (e.g., servers 120 and/or servers 140).

At block 704, the electronic device may output, based on the audio content, music (e.g., music 202) with a speaker (e.g., speaker 200) that is communicatively coupled to the electronic device (e.g., a speaker of a display device 123 and/or a speaker device 127). For example, the speaker may be a speaker of the electronic device. As another example, the speaker may be a speaker that is disposed in another electronic device, such as a display device 123 or a speaker device 127 that is communicatively coupled to the electronic device via a wired or wireless connection. In one or more implementations, the electronic device (e.g., audio content separation block 300 running on processor 208) may separate a music portion (e.g., music portion 301) in the audio content from a voice portion (e.g., voice portion 303) in the audio content, prior to outputting the music with the speaker.

At block 706, the electronic device may receive, wirelessly from another electronic device (e.g., electronic device 104 and/or audio output device 150), an audio input stream (e.g., microphone signal 214) including the music output by the speaker and including a voice (e.g., voice 203) of a person (e.g., person 204). For example, the other electronic device may include one or more microphones (e.g., microphone(s) 206, 506, 508, and/or other microphones) that receive both the voice 203 of the person 204 and the music 202 output by the speaker 200. The other electronic device may capture the audio input stream using the one or more microphones, and transmit (e.g., wirelessly) the audio input stream to the electronic device.

At block 708, the electronic device (e.g., music cancelation block 302 running on processor 216) may separate the voice of the person from the music in the audio input stream to generate a voice stream (e.g., voice stream 305 or voices stream 307) including the voice of the person (e.g., as described herein in connection with FIG. 3 or FIG. 4).

At block 710, the electronic device (e.g., enhancement and/or mixing block 306) may combine the voice stream with the audio content (e.g., with the music portion 301 of the audio content and/or some, none, or all of the voice portion 303 of the audio content) to generate a combined output (e.g., combined output 218 and/or combined feedback output 518). In one or more implementations, the electronic device may also perform noise suppression operations and/or dereverberation operations on the voice stream prior to combining the voice stream with the audio content. As discussed herein, combining the voice stream with the audio content may include (i) remixing the audio content, (ii) including various amounts of a voice of an original signal, (iii) including various amounts of the voice stream, (iv) filtering the voice stream or the audio content, (v) style modification of the voice stream (e.g., to match a style of the music or the original signer), and/or (vi) spatialization operations (e.g., the move the apparent location of the voice of the person in the combined output, and/or to cancel an in-the-head portion of the voice of the person, as heard by the person).

At block 712, the electronic device may provide the combined output for at least one of: storage or playback (e.g., later playback or real-time playback for feedback while singing).

As described above, one aspect of the present technology is the gathering and use of data available from specific and legitimate sources for voice over music recording. The present disclosure contemplates that in some instances, this gathered data may include personal information data that uniquely identifies or can be used to identify a specific person. Such personal information data can include audio data, voice samples, voice profiles, voice streams, demographic data, location-based data, online identifiers, telephone numbers, email addresses, home addresses, biometric data or records relating to a user's health or level of fitness (e.g., vital signs measurements, medication information, exercise information, motion information, workout information), date of birth, or any other personal information.

The present disclosure recognizes that the use of such personal information data, in the present technology, can be used to the benefit of users. For example, the personal information data can be used for voice over music recording.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the example of voice over music recording, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 8 illustrates an electronic system 800 with which one or more implementations of the subject technology may be implemented. The electronic system 800 can be, and/or can be a part of, the audio output device 150, the display device 123, the media output device 115, the speaker device 127, the electronic device 104, the server(s) 120, and/or the server(s) 140 as shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810 (which are each implemented as a non-transitory computer-readable medium). From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In accordance with aspects of the disclosure, a method is provided that includes, obtaining, using one or more microphones of an electronic device, an audio input stream comprising: a voice of a person from a first source, and music from a second source that differs from the first source; separating, by the electronic device, the voice of the person from the music to generate a voice stream including the voice of the person; obtaining audio content corresponding to the music; combining, by the electronic device, the voice stream with the audio content corresponding to the music to generate a combined output; and providing, by the electronic device, the combined output for at least one of: storage or playback.

In accordance with aspects of the disclosure, a method is provided that includes obtaining, by an electronic device, audio content; outputting, by the electronic device and based on the audio content, music with a speaker that is communicatively coupled to the electronic device; receiving, at the electronic device wirelessly from another electronic device, an audio input stream including the music output by the speaker and a voice of a person; separating, at the electronic device, the voice of the person from the music in the audio input stream to generate a voice stream including the voice of the person; combining, at the electronic device, the voice stream with the audio content to generate a combined output; and providing, at the electronic device, the combined output for at least one of: storage or playback.

In accordance with aspects of the disclosure, a device is provided that includes at least one microphone; and one or more processors configured to: obtain, using at least one microphone, an audio input stream comprising a voice of a person from a first source and music from a second source that differs from the first source; separate the voice of the person from the music to generate a voice stream including the voice of the person; obtain audio content corresponding to the music; combine the voice stream with audio content to generate a combined output; and provide the combined output for at least one of: storage or playback.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

What is claimed is:

1. A method, comprising:
obtaining, using one or more microphones of an electronic device, an audio input stream comprising: a voice of a person from a first source, and music from a second source that differs from the first source;
separating, by the electronic device, the voice of the person from the music to generate a voice stream including the voice of the person;
obtaining audio content corresponding to the music;
combining, by the electronic device, the voice stream with the audio content corresponding to the music to generate a combined output; and
providing, by the electronic device, the combined output for at least one of: storage or playback.

2. The method of claim 1, wherein the second source comprises a speaker of the electronic device, the method further comprising outputting the music with the speaker by operating the speaker based on the audio content.

3. The method of claim 2, wherein operating the speaker based on the audio content comprises:
separating, by the electronic device, a portion of the audio content corresponding to the music and a portion of the audio content corresponding to an original singer of the music; and
operating the speaker, based on the portion of the audio content corresponding to the music.

4. The method of claim 3, further comprising:
operating the speaker, based on the portion of the audio content corresponding to the original singer of the music, to output a user-controllable amount of the original singer of the music.

5. The method of claim 1, wherein the first source comprises the person, and wherein the second source comprises a speaker of another electronic device.

6. The method of claim 1, wherein combining the voice stream with the audio content comprises:
modifying a style of the voice stream; and
combining the voice stream, with the style having been modified, with the audio content.

7. The method of claim 6, wherein modifying the style of the voice stream comprises modifying the style based on a style detected by the electronic device in the audio content.

8. The method of claim 7, wherein modifying the style based on the style detected by the electronic device in the audio content comprises:
detecting a reverb style in the audio content; and
applying the reverb style to the voice stream.

9. The method of claim 1, wherein combining the voice stream with the audio content comprises:
remixing a portion of the audio content; and
combining the voice stream with the audio content with the portion having been remixed.

10. The method of claim 9, wherein remixing the portion of the audio content comprises modifying a first amount of a voice of an original singer of the music in the audio content.

11. The method of claim 10, further comprising modifying, based on a user input to the electronic device, a second amount of the voice of the original singer of the music in the music from the second source.

12. The method of claim 11, wherein modifying the second amount of the voice of the original singer of the music in the music from the second source comprises modifying the second amount of the voice of the original singer of the music in the music from the second source without affecting the modified first amount of the voice of the original singer of the music in the audio content that is combined with the voice stream.

13. The method of claim 1, wherein providing the combined output for at least one of storage or playback comprises providing a first combined output for storage and providing a second combined output for real-time playback by a personal audio device during the obtaining of the audio input stream.

14. The method of claim 13, wherein the personal audio device comprises an earbud or headphones having a speaker that provides a speaker output directly to an ear of the person.

15. The method of claim 13, wherein providing the first combined output for storage comprises combining a first amount of the voice stream with the audio content, and wherein providing the second combined output for real-time playback comprises combining a second amount of the voice stream, different from the first amount of the voice stream, with the audio content.

16. The method of claim 15, wherein the second amount is greater than the first amount to facilitate the person hearing their own voice during the obtaining of the audio input stream.

17. The method of claim 13, wherein providing the second combined output for real-time playback comprises modifying an original spatial distribution of the voice stream to an updated spatial distribution of the voice stream in the second combined output.

18. The method of claim 17, wherein the original spatial distribution of the voice stream is based on a location of the one or more microphones of the electronic device relative to a mouth of the person, and wherein the updated spatial distribution of the voice stream is independent of the location of the one or more microphones.

19. The method of claim 18, wherein the updated spatial distribution of the voice stream is configured to, when output by a plurality of speakers of an audio output device, be perceived as originating from a mouth of the person.

20. The method of claim 18, wherein the updated spatial distribution of the voice stream is configured to be perceived, when output by a plurality of speakers of an audio output device, as originating from a location separate from the location of the one or more microphones and separate from a location of a mouth of the person.

21. The method of claim 18, wherein modifying the original spatial distribution comprises generating a portion of the voice stream that is configured to, when output by a plurality of speakers of an audio output device, cancel a portion of the voice of the person that is transmitted to an ear of the person from within a head of the person.

22. The method of claim 1, further comprising applying a filter, learned by the electronic device, to the combined output.

23. The method of claim 1, further comprising:
receiving, by the electronic device from another electronic device, an additional voice stream comprising an additional voice of an additional person; and
combining the voice stream and the additional voice stream with the audio content corresponding to the music to generate the combined output.

24. A method, comprising:
obtaining, by an electronic device, audio content;
outputting, by the electronic device and based on the audio content, music with a speaker that is communicatively coupled to the electronic device;
receiving, at the electronic device wirelessly from another electronic device, an audio input stream including the music output by the speaker and a voice of a person;
separating, at the electronic device, the voice of the person from the music in the audio input stream to generate a voice stream including the voice of the person;
combining, at the electronic device, the voice stream with the audio content to generate a combined output; and
providing, at the electronic device, the combined output for at least one of: storage or playback.

25. A device, comprising:
at least one microphone; and
one or more processors configured to:
obtain, using at least one microphone, an audio input stream comprising a voice of a person from a first source and music from a second source that differs from the first source;
separate the voice of the person from the music to generate a voice stream including the voice of the person;
obtain audio content corresponding to the music;
combine the voice stream with audio content to generate a combined output; and
provide the combined output for at least one of: storage or playback.

26. The device of claim 25, wherein the one or more processors are further configured to perform a noise suppression operation and a dereverberation operation on the voice stream prior to combining the voice stream with the audio content.
